(19) United States
(12) Patent Application Publication
(10) Pub. No.: US 2007/0201624 A1
(43) Pub. Date: Aug. 30, 2007

(54) Protection Phone

(76) Inventor: Elizabeth Anne Testino, Wildwood, NJ (US)

Correspondence Address: Elizabeth Testino, P.O. Box 2553, Wildwood, NJ, 08260, US

(21) Appl. No.: 11/351,384

(22) Filed: Feb. 10, 2006

(51) Int. Cl. H04M 11/04

(52) U.S. Cl. 379/45

(57) ABSTRACT

This invention will contain new computer technology to keep the line of communication open to 911 centers by a locked speaker system with locked location system in the event of emergencies. Final disconnection of phones and cell phones can only be done by the 911 centers allowing them to better access the situation. It will also be of great help to the police departments, saving time and allowing them to better prepare for different emergencies. The phones will also contain a battery back up device to aid when cell phone or phone power is unable to finish communication.

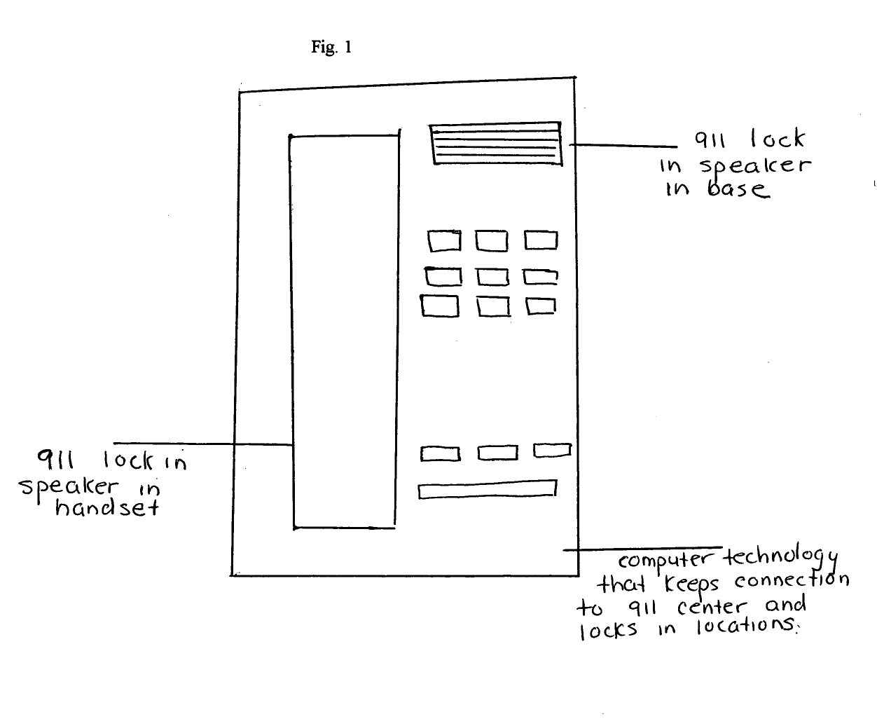

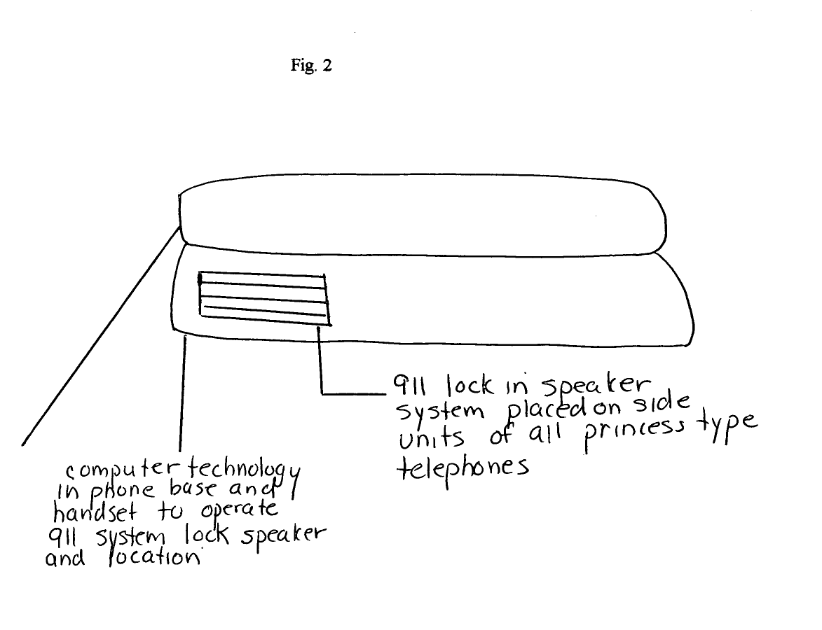

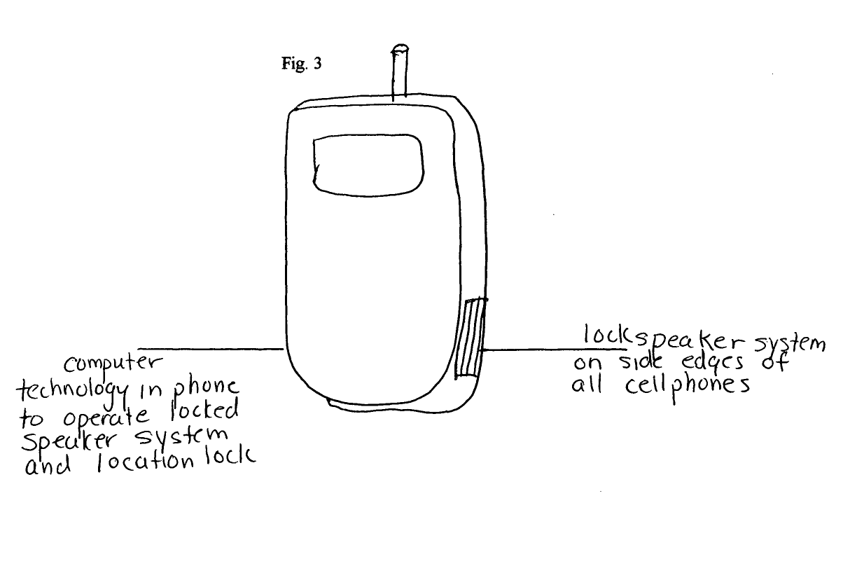

### CROSS REFERENCE TO RELATED APPLICATIONS

To my knowledge I know of no other telephones that have these features.

### STATEMENT REGARDING FEDERALLY SPONSORED RESEARCH AND DEVELOPMENT

Non applicable

### REFERENCE TO A SEQUENCE LISTING, A TABLE, OR COMPUTER PROGRAM LISTING COMPACT DISC APPENDIX

Non applicable

### BACKGROUND OF THE INVENTION

The idea for this invention came many years ago after hearing of so many incidents where people tried to call 911 and help didn't arrive for a number of reasons, examples to follow.

### BRIEF SUMMARY OF THE INVENTION

The most important aspect of my invention is that it is designed to save lives. It also helps the police departments, saving time and distinguishing between different 911 calls. It will let them know what they are up against, whether it be a fire, a perpetrator, if anyone is armed, what part of the house they are in and if medical help is needed.

### BRIEF DESCRIPTION OF SEVERAL VIEWS OF THE DRAWING

The drawing consists of a standard telephone, a cordless telephone and a cell phone. The components inside the phones will allow them to become the safety phones.

### DETAILED DESCRIPTION OF THE INVENTION

The safety phones will be able to help people in the event of emergencies.

### EXAMPLES

a. A person is being attacked in their home, it's the person they have a restraining order against, she didn't get to tell her address, he hung up the phone on her.
b. The battery is low, the phone goes off, they didn't get to tell 911 their location.
c. You hear someone coming in your house and dial 911, but they are already inside, you drop the phone and hide.
d. You are in your car, someone is trying to get in, you dial 911 but he grabs the phone and throws it down.
e. Someone calls, 911 then hangs up, you have no idea where it came from but you think it was a child. Etc.

My invention is as follows, when a person dials 911 and it connects to the center it will be locked on and cannot be turned off even if they shut off the phone or hang it up. When 911 is dialed a speaker system is activated within the phone and cannot be turned off. The 911 center is the only one that can disconnect that call once it is placed. At that same time a tracking device and emergency battery back up goes on. This enables the 911 center to hear exactly what is going on in emergency situations without being disconnected by anyone. If you have one or more of these phones on the same phone line in different parts of the home they will all automatically activate.

There are so many instances where these phones would be a help. People being stalked, battered women who fear for their lives, fires in the home, breaking and entering, etc. Knowing you will have an open line when danger occurs will give people a better sense of security. It is like having a personal security system at all times.

So many 911 calls are missed dials, pranks, or incomplete calls, costing the police so much precious time that can be used for emergencies.

My invention will be made from the pre-existing structure of telephones and cell phones, but will be enhanced with computer technology to allow it to preform the duties of the protection phone.

1. I claim my invention will help to save the lives of many people in many different and difficult situations. It will save the police and fire departments much needed time and better prepare them when confronting dangerous circumstances. Parents will feel their children have some protection when away from home, and in the home it will be like having a security system right from your own phone system.
